(19) United States
(12) Patent Application Publication
(10) Pub. No.: US 2023/0214860 A1
(43) Pub. Date: Jul. 6, 2023

(54) Model of Brand Health

(71) Applicant: OZYEGIN UNIVERSITESI, Istanbul (TR)

(72) Inventor: Munir Tolga AKCURA, Istanbul (TR)

(73) Assignee: OZYEGIN UNIVERSITESI, Istanbul (TR)

(21) Appl. No.: 17/565,471

(22) Filed: Dec. 30, 2021

(51) Int. Cl. G06Q 30/02; G06Q 10/06

(52) U.S. Cl. CPC G06Q 30/0202; G06Q 10/06315; G06Q 10/06375

(57) ABSTRACT

Systems and methods for measuring a brand health of a brand in real-time and the subsequent allocating of resources. The system comprises at least one device having at least one processor, at one least memory device storing instructions that are executable on the at least one processor, and a non-transitory, computer-readable medium embodying computer program code to implement a method for measuring the brand health of the brand in real-time. The method entails obtaining unique IDs who engage with both the brand and competing brands during a period of time; determining a set of real-time coefficients of the brand; calculating a market share of the brand via the use of the coefficients; calculating the brand health of the brand in real-time via the use of both the market share and real-time coefficients of the brand, and allocating, based on the brand health of the brand, marketing resources for the brand.

### TECHNICAL FIELD

The present invention relates to a method and system of measuring the health of a brand in real-time via the use of a model of brand health or a brand health model, which pertains to the technical field of Performance Marketing Technologies, Information Communication Technologies (ICT), and Management Information Systems (MIS).

### BACKGROUND

The traditional brands face the threat of disruption and cannot adopt to the era of zero-moment-of truth, smart phones and accountable actions as digital and social communications gain more prevalence over traditional means of communication. The technology-intensive applications and their real-time nature are instilling skepticism behind the traditional brand management and the “cash-is-king” approach is dominating. As the skepticism towards traditional approaches grows, unless measured and justified, marketing expenses are closely interrogated. A potential cause is that traditional brands cannot successfully connect with the new generation of customers and are falling short of expectations. There are numerous reports on consumers favoring smaller, cost-efficient rivals at the expense of big brands. Many new startups question the need and necessity of investing on brands.

When it comes to strategic brand decision-making with long term implications, the inability of justifying the investment on brand can be quite detrimental. The short-term tactical objectives such as sales-push must be evaluated simultaneously with a view on long-term brand related considerations. Not having an ability to trade-off long-term brand health versus short term cash flow priorities, the managers in venerable brands cannot guide their investments and justify their brand related actions. As a result, funding for traditional brands has dropped in favor of short-term cash flow priorities resulting in painful market share losses.

Traditional drivers are falling short when measuring brand success. A lack of ability in incorporating real-time data and addressing new realities and business models provide further limitations. For example, neither price premium nor advertising expenditures, key components of existing brand equity measurements, may be meaningful for successful brands. In addition, the metrics that are based on surveys or expert judgements are discreet and lagging indicators at best. The available solutions mostly employ discreet studies that rely extensively on surveys, expert judgments and subjective evaluations which are quite costly and hard to replicate. Scanner panels, retail sales, choice experiments and stock prices do not provide timely information for key brand management decisions that involve qualitative brand elements such as creative campaigns. Thus, it is not surprising to see that the current models cannot be of help for brand managers who are in need of accountable real-time actions. Most brand managers would like to know the direction of the brand as positive or negative and identify the relative impact of their actions as effective or not close to real time.

Engagement and behavioral observations obtained from social media have the potential to identify key metrics such as brand awareness, associations, related attitudes, and loyalty real time. Although there are numerous studies that connect basic social media metrics such as content volume and valence with brand sales, connecting social media with brand performance remains a challenge. Ad hoc approaches shaped by many start-ups and social media platforms' own specific metrics provide few alternatives for practitioners. Platform specific social media metrics (e.g., like, retweet, etc.) serve to get more advertisement dollars for the platforms with no clear ties to the top line revenue growth for brands. Many Chief Marketing Officers (CMOs) approach social media platforms' metric-related peddling efforts with doubts and most find them specious. Moreover, random commercial indices add to the marketing managers' confusions with no clear benefit. Defining right approaches, metrics, and models remains challenging.

Measuring the health, in the case of humans, requires monitoring certain metrics, such as heartbeat and blood pressure against pre-defined ranges. In the case of brands, looking at the communications in general, including any user generated content provide significant data. Communications, related credibility and sales responsiveness are signs of successful branding. Given a brand, certain periods may have superior market share contributions but with differing long-term branding implications. There is a need to have close-to-real-time indicators and strong information systems infrastructure.

Thus, there is a need to develop a model of brand health or a brand health model that provides the measurement of a brand health in real-time via the use of widely available data metrics.

### SUMMARY

Different from conventional solutions, the disclosed method and system solves the above problem by providing a model of brand health or a brand health model that provides the measurement of a brand health in real-time via the use of widely available data metrics.

Answering the calls for the emerging importance of dynamic resources and information systems ability to create sustainable competitive advantages, this invention proposes a novel set of metrics and an econometric model that can be used for brand decision support. The model simultaneously captures and disentangles the short-term sales impact from the long-term branding success. The basic premise behind the model is that a healthy brand is supposed to provide a superior contribution to market share compared to an unhealthy brand given the same level of communication.

In the proposed approach, brand health is modeled as a state that evolves based on the expected versus actual experienced (sales) differences. This structure allows for immediate feedback towards whether and how certain brand actions (TV, digital, grass roots, etc.) and/or market related developments (e.g., competition, user contents, social trends, etc.) influence the brand health. The proposed model identifies jointly the states with a superior contribution to market share while allowing for the negative purchase feedback. The states where communications and experiences together provide a higher impact on market share indicate increasing health.

The proposed model uses a monthly analysis where market share is the dependent variable. Individual engagements are readily observed by monitoring social media. Having individual-level social data provides a significant advantage to create the right set of metrics with significant roles on sales. This invention proposes a novel approach in creating meaningful social media metrics for branding purposes. The metrics can be tracked real time and the model can be built as a decision support mechanism on setting the communication and brand strategy.

Metrics such as mentions and positive negative ratio in a vacuum are hardly useful for managers. In addition, it is possible to manipulate these metrics using automated posts and patterns as these metrics are based on volume. In contrast, the proposed metrics are based on unique IDs and the number of unique IDs is harder to manipulate. Further, these metrics are obtained using an individual-level brand affinity analysis. The metrics simultaneously control for content valence, volume and variance and add new research perspectives to what matters when and for whom.

In a first aspect, the invention discloses a method for measuring a brand health of a brand in real-time, comprising obtaining, by one or more devices having a processor, unique IDs who engage with both the brand and competing brands during a period of time; determining, by the one or more devices having a processor, a set of coefficients of the brand, wherein the coefficients are real-time coefficients that further comprise: mindshare metrics, brand affinity metrics, other variables of interest, and period-specific unobservable impacts; calculating, by the one or more devices having a processor, a market share of the brand via the use of the real-time coefficients; calculating, by the one or more devices having a processor, the brand health of the brand in real-time via the use of the market share of the brand and the coefficients of the brand; allocating, based on the brand health of the brand, marketing resources for the brand.

In another aspect, the method's mindshare metrics are calculated by dividing a number of unique IDs who engage with the brand over a number of unique IDs who engage with both the brand and the competing brands. Moreover, in yet another aspect, a positive mindshare is calculated by dividing a number of unique IDs who generated positive content when engaging with the brand by a number of unique IDs who generated positive content when engaging with both the brand and the competing brands and wherein a negative mindshare is calculated by dividing a number of unique IDs who generated negative content when engaging with the brand by a number of unique IDs who generated negative content when engaging with both the brand and the competing brands.

In another aspect, the method's other variables of interest may include at least one of a price of the brand, a price of the brand in a set period of time, trade and distribution support of the brand, or merchandising of the brand. In yet another aspect, the period-specific unobservable impacts include at least one of seasonal promotions of the brand or spatial promotions of the brand.

In a further aspect, the brand affinity metrics comprise at least one of newcomers, incomers, outgoers, or existings such that the newcomers are calculated by aggregating unique IDs who are newly engaging with the brand and the competing brands, the incomers are calculated by aggregating unique IDs who previously engaged positively the most with the competing brands but have since switched to engage positively the most with the brand, the outgoers are calculated by aggregating unique IDs who previously engaged positively the most with the brand but have since switched to engage positively the most with the competing brands, and the existings are calculated by aggregating unique IDs who have maintained positive engagement with the brand.

In another aspect, the marketing resources include at least one of media buying, campaign spending, marketing expenditures, product modifications, or product pricing. the invention discloses a method for measuring a brand health of a brand in real-time, comprising obtaining, by one or more devices having a processor, unique IDs who engage with both the brand and competing brands during a period of time; determining, by the one or more devices having a processor, a set of coefficients of the brand, wherein the coefficients are real-time coefficients that further comprise: mindshare metrics, brand affinity metrics, other variables of interest, and period-specific unobservable impacts; calculating, by the one or more devices having a processor, a market share of the brand via the use of the real-time coefficients; calculating, by the one or more devices having a processor, the brand health of the brand in real-time via the use of the market share of the brand and the coefficients of the brand; supporting, based on the brand health of the brand, decisions to improve the brand health of the brand.

In a further aspect, the decisions include at least one of pivoting market campaigns, identifying product designs, identifying product formulations, or experimenting with different brand positioning statements.

In yet another aspect, the present disclosure discloses a system of measuring a brand health of a brand in real-time, the system comprising: at least one device having at least one processor, at least one memory device storing instructions that are executable on the at least one processor, a non-transitory, computer-readable medium embodying computer program code, the computer-usable medium being coupled to the at least one device, the computer program code interacting with a plurality of computer operations to implement the aforementioned method of measuring brand health and thereafter allocating, based on the brand health of the brand, marketing resources for the brand.

In a further aspect, the present disclosure discloses a system of measuring a brand health of a brand in real-time, the system comprising: at least one device having at least one processor, at least one memory device storing instructions that are executable on the at least one processor, a non-transitory, computer-readable medium embodying computer program code, the computer-usable medium being coupled to the at least one device, the computer program code interacting with a plurality of computer operations to implement the aforementioned method of measuring brand health and thereafter supporting, based on the brand health of the brand, decisions to improve the brand health of the brand.

In another aspect, the present disclosure discloses a non-transitory, computer-readable medium embodying computer program code, the computer program code interacting with a plurality of computer operations to implement the aforementioned method of measuring brand health thereafter allocating, based on the brand health of the brand, marketing resources for the brand.

In a further aspect, the present disclosure discloses a non-transitory, computer-readable medium embodying computer program code, the computer program code interacting with a plurality of computer operations to implement the aforementioned method of measuring brand health thereafter supporting, based on the brand health of the brand, decisions to improve the brand health of the brand.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 illustrates an example of the model of brand health or the brand health model of the disclosure.

FIG. 2 illustrates an example filtering mechanism utilized by the model of brand health or the brand health model of the disclosure

FIG. 3 illustrates a table of empirical data showing the Market Shares and Prices for each of Brands A, B, and C.

FIG. 4 illustrates a graph of empirical data showing Mindshare, Existings and Coefficients for each of Brands A, B, and C.

FIG. 5 illustrates a table of empirical data showing the percent of data volume across various social media platforms for each of Brands A, B, and C.

FIG. 6 illustrates a table showing the operationalization of Social Media Metrics.

FIG. 7 illustrates a table of empirical data showing the Descriptives of Mindshare and Brand Affinity for each of Brands A, B, and C.

FIG. 8 illustrates a graph and table of empirical data showing the correlation of data for each of Brands A, B, and C.

FIG. 9 illustrates a graph of empirical data showing the Market Share, Mindshare, Existings, and Price for each of Brands A, B, and C.

FIG. 10 illustrates a table of empirical data showing the variance and covariance data for each of Brands A, B, and C.

FIG. 11 illustrates a graph of empirical data showing the Brand Healths and Market Shares for each of Brands A, B, and C.

FIG. 12 illustrates a graph of empirical data showing the Brand Health Strips for each of Brands A, B, and C.

FIG. 13 illustrates a graph of empirical data showing Mindshare and Existings effects on Brand Health for each of Brands A, B, and C.

FIG. 14 illustrates an example device utilized by the model of brand health or the brand health model of the disclosure.

FIG. 15 illustrates an example non-transitory, computer-readable medium that implements a method utilized by the model of brand health or the brand health model of the disclosure.

FIG. 16 illustrates an example system that implements the model of brand health or the brand health model of the disclosure.

FIG. 17 is a flowchart illustrating an example method of the disclosure.

FIG. 18 is a flowchart illustrating an example method of the disclosure.

### DETAILED DESCRIPTION

The present invention will be further described hereinafter with reference to the specific figures.

A brand links today to tomorrow while communications and the brand's interactions with people represent the heart of branding. Much can be boiled down to communications, starting from the product's packaging, shared experiences and word-of-mouth, trade efforts and in-store experiences such as display, shelf space, pricing, advertising and promotions. If one can decipher the true signals based on communications, the state of a brand's heart can be monitored. A proper way to understand the consumer behavior should start with a deep understanding of the individuals and their preferences. It has been shown that the individual-level engagements, information search, evoked sets and brand retrievability lead to superior choice predictions and brand diagnostics.

A first step in understanding the consumer behavior is to identify the decision-making context, or the competing brands that may act as substitutes. There may be significant heterogeneity among different individuals' consideration sets that may include potentially very dissimilar brands. For example, consider that one is interested in understanding the consumer behavior in alcoholic beverages. Then, the context requires capturing all alcoholic beverage brands that individuals may access and substitute one for another. This substitution may be in the same category, i.e., a beer for another beer, or in a competing category, a beer for a vodka or wine.

One can identify the brand substitutions by observing the engagements of individuals with the brands in social media. For example, someone liking or retweeting content that has a brand asset may be deemed as moving closer to the brand's affinity and more likely to having a perception that the product is “for me”. Similarly, an engagement with a competing brand may result in the individual moving away from the brand and getting closer to a competing brand. The context in this research means the brand space where all the relevant engagements and information can be obtained. All brands and their proxies such as hashtags, specific campaigns and sponsorships has the ability to directly link the content with the brand help to define the context. Thus, for the case of alcoholic beverages, for example, observations allow for identifying whether an individual is staying in a given category (e.g., only engaging with beers) or moving across different categories (e.g., simultaneously considering beers, wines and vodkas).

There can be different brand affinity metrics capturing the journey of an individual in a given context. Newcomers, Incomers, Outgoers and Existings are the ones that can identify an individual's brand affinity. A newcomer is an author who is engaging for the first time with the sector and with a specific brand simultaneously. Incomers, on the other hand, are the individuals who had a different brand's affinity before but moved to the current brand's affinity during the period. Outgoers are vice versa, meaning they represent individuals who had the current brand's affinity before but moved to a different brand's affinity during the period. Existings are the ones who stay with the same brand during the period.

Brand affinity requires an awareness, interest, and desire. In social media, given the challenges associated with capturing attention, and the high frequency of engagements, shared contents can be seen as signals of advertising effort. Mindshare combines awareness and interest. The number of unique individuals engaging with the brand, over the number of unique individuals engaging with all the brands in the sector in a given period gives a brand's Mindshare. Although focusing on volume may be sufficient for well differentiated brands, valence may identify desire and influence sales, though with potential biases. One can also include positive engagements and negative engagements by creating positive or negative Mindshares. Positive Mindshare is calculated using unique authors who generate positive contents with a specific brand divided by all the unique authors who generate positive contents with all the brands in a given period. Although Mindshare is calculated at the brand and context level, Brand Affinity is calculated at the individual level. A brand's affinity requires identifying individuals with positive engagements. An individual who has the highest number of positive engagements with a brand compared to all other brands over a period is said to be of that specific brand's affinity. A brand's affinity metrics and its Mindshares should relate to its market share. It has been established that market share is the most used metric in analyzing product-market performance. The following summarize the discussions so far:

Statement 1 (Regarding Brand Affinity): Brand Affinity metrics and Mindshares are related to market shares.

When consumers are exposed to a brand's communications, consumers may be more inclined to purchase and/or produce content related to the brand. The first part is related to the quality of the communications, the second part increases the content volume, not necessarily increasing the sales. Depending on the quality of communications and the created attractiveness in the market, brand affinity and market share impacts change across different periods.

Statement 2 (Regarding the time varying nature): Brand Affinity metrics' and Mindshares' impacts on market shares change as a function of time.

So far, none of the above statements directionally link these changes to a brand's wellbeing. The most effective brand affinity gain is observed when content quantity (the number of observations or consumers with the brand's affinity) and quality (impact on sales) increase simultaneously. A firm can magnify the quantity rather easily by increasing the budget and multiplying the contents. However, quality is the main challenge. For the periods when increases in quantity are counteracted by decreases in quality, the market share may not change and the effort may be wasted. When it comes to measuring a brand, its health state is mode dependent on the quality effect. Statement 2 above requires checking the response coefficients' and parameters' time-varying nature. That is, the responses on market shares may increase or decrease in time. This can be tested by estimating the impact of lapsed time on different coefficients. If new observations do not change the responses, a rather stable set of estimates should be obtained as new observations are included with time. Alternatively, the estimates may show trends.

The direction and amplitude of Brand Affinity metrics' and Mindshares' impacts in time are all relevant for a brand to claim health. A healthy brand's market share should increase when coefficients such as Mindshare increases and Brand Affinity gain is positive. However, there may be other coefficients that affect and influence market share and, in turn, brand health. These other coefficients may include, for example, other variables of interest and period-specific unobservable impacts affecting the market share and, in turn, the brand health. The other variables of interest may include the price of the brand, trade and distribution support of the brand, merchandising and activations. The period-specific unobservable impacts may include promotions of the brand, promotional interactions with personnel marketing the brand, and the organization pattern of the point-of-purchase locale (such as a supermarket, mall, etc.) promoting the brand, among other impacts.

Such above coefficients can be highlighted in the following manner: for example, for an established brand with a significant market share, taking the consumers to a point of purchase may be parallel to increasing the aforementioned Mindshares and Brand Affinity metrics. Thereafter, there exists a black box of coefficients wherein the purchase occurs. The consumer either sees the brand in a self-service supermarket or interacts with the specific sales environment in restaurants or bars wherein all such factors represent coefficients. In addition, there may be unobserved promotions in this specific sales environment or marketing actions including price that play an important role in customer acquisition and retention wherein all such factors represent coefficients. Naturally, the coefficients are not restricted to the above-listed metrics and may entail a plethora of factors that are related to brand health, brand market share, and/or other brand-related metrics.

The next third statement introduces brand health as the ability to gain market share and links the brand health with Mindshare and Brand Affinity:

Statement 3 (brand health): Brand health is the ability to gain future market share through the previous period's unit Brand Affinity, Mindshare, and price increases as well as through other potentially unobserved period-specific actions. Positive and higher levels of impacts for additional units of changes associated with these variables are signs of improving brand health.

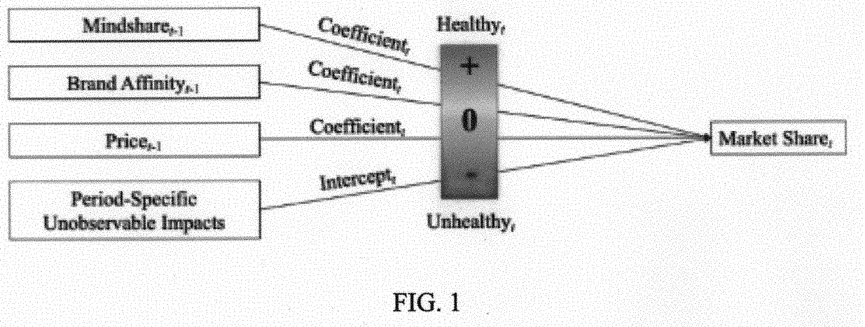

Quantifying and tracking brand health represents the present invention's brand health model. A time varying coefficient and parameter model suits this purpose. A representation of this model is given in FIG. 1 wherein a series of coefficients, also known as higher coefficients, suggest increasing brand health. As seen in FIG. 1, such coefficients include the aforementioned Mindshare, Brand Affinity, Price of the Brand, and Period-Specific Unobservable Impacts. The following is an analytical representation of the present invention's model that is shown in FIG. 1:

$${Y}_{b , t} = {B}_{b , t} + {A}_{b , t} {Y}_{b , t - 1} + {O}_{b , t} \qquad ( 1 )$$

$${[ \begin{matrix}b \\ vec ( A )\end{matrix} ]}_{b , t} = {[ \begin{matrix}B \\ vec ( A )\end{matrix} ]}_{b , t - 1} + {S}_{b , t} \qquad ( 2 )$$

Wherein Y is the vector that includes market share, Mindshare and Brand Affinity metrics and any other variable of interest (i.e., price), with the dimension K×1; wherein [B]_{K×1} is the vector of intercepts and |A|_{K×K} is the matrix of coefficients. Moreover, b represents brand and t represents time. Furthermore, O_{b,t}˜N(0,Σ_{O,b}), S_{b,t}˜N(0,Σ_{S,b}), O_{b,t}⊥S_{b,t} and the vec(⋅) operator vectorizes the (transposed) matrix by stacking columns on top of each other. Equation (1) uses the observations that O_{b,t} is the vector of the observation error. With Equation (2), the intercept and response coefficients gain a dynamic nature where they change from one period to another. According to Equation (2), this change follows a random walk. The random walk acknowledges that the specific level in one period is highly dependent on the level on the previous period, but, simultaneously, presents the advantages of focusing on permanent shifts and reducing the number of estimation parameters. The purpose is to identify the shifts that cause future market shares. One can think of Equation (2) as evolving with a carry-over coefficient. Estimating Equation (2) reveals that the coefficient is close to 0.99. A Random walk specification provides a simple yet powerful way to acknowledge the high state-dependence of the parameters and its associated data.

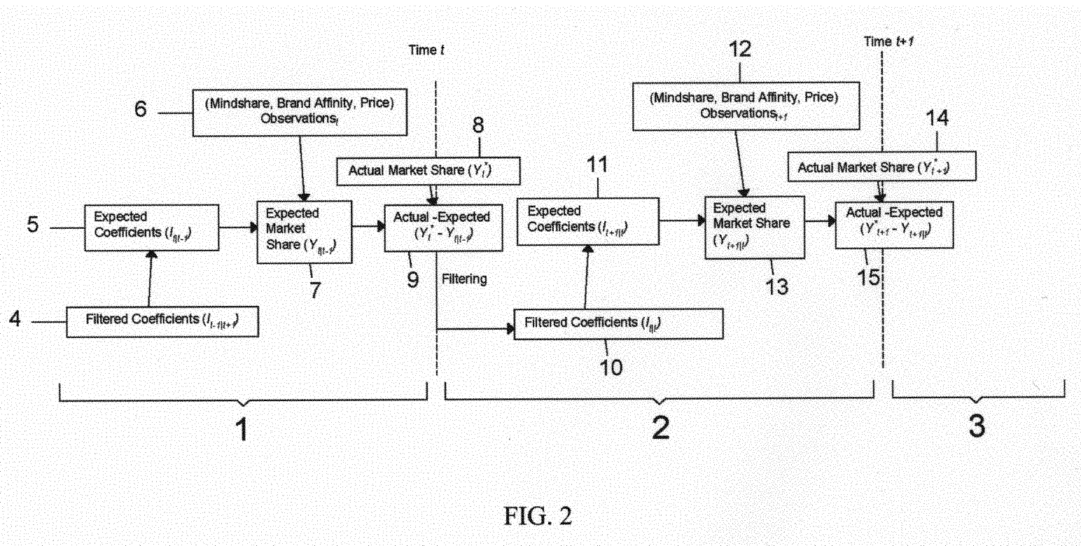

According to Statement 3 above, as the level of positive impact on market share increases the brand's health also increases. Conversely, as the level of positive impact on marker share decreases, the brand's health also decreases. Henceforth, a discussion will commence as to the attainment, gathering, and filtering of the appropriate coefficients wherein such a filtering mechanism is shown in FIG. 2. Let t|t−1 represent all the past information available till t except the observations obtained at the end of t, wherein t|t−1 is represented by reference number 1 in FIG. 2. As seen in FIG. 2, reference number 2 represents the information available in period t from t till t+1, whereas reference number 3 represents the information available beyond t+1.

For simplicity, let vector I represent the unobserved vector, obtained by stacking B and vec(A). Note that the size of I is K+K². Below, the subscript b is suppressed for ease of exposition—Equation (2) then becomes:

Iₜ=Iₜ₋₁+Sₜ (3)

As mentioned above, let t|t−1 represent all the past information available till t except the observations obtained at the end of t, wherein t|t−1 is represented by reference number 1 in FIG. 2. At a given point represented by t|t−1, the system of equations (1) and (2) is:

Y_{t|t-1}=B_{t|t-1}+A_{t|t-1}Y_{t-1|t-1}+Oₜ (4)

I_{t|t-1}=I_{t-1|t-1}+Sₜ (5)

Equation (4) can be used to find the expected value for Y_{t|t-1}, as shown by reference number 7 in FIG. 2. The expectation of I_{t|t-1}, seen as reference number 5 in FIG. 2, readily provides B_{t|t-1} and A_{t|t-1}. Once period t concludes, the observations are revealed. Let these observations be represented by Yₜ*, seen as reference number 8 in FIG. 2. The difference between the observations Yₜ* and expectations Ŷ_{t|t-1}, represented by reference number 9 in FIG. 2, provides an added signal. This signal can be used to filer I_{t|t}, represented by reference number 10 in FIG. 2. To see that, note that Equation (1) and Equation (2) are jointly normal, and ex-post the observations, I_{t|t} and Σ_{S,t|t} given Yₜ* becomes:

I_{t|t}=I_{t|t-1}+Σ_{S,t|t-1}(Σ_{S,t|t-1}+Σ_{O,t|t-1})⁻¹(Yₜ*−Ŷ_{t|t-1}) (6)

Σ_{S,t|t}=Σ_{S,t|t-1}−Σ_{S,t|t-1}(Σ_{O}+Σ_{S,t|t-1})⁻¹Σ_{S,t|t-1} (7)

This filtering step, as shown by the totality of FIG. 2, enables to account for period-specific updating of the coefficients. One of the challenges in dealing with an aggregate market-performance metric such as market share is dealing with heterogeneity. The proposed model is estimated with a Markov chain Monte Carlo (MCMC) technique and the resulting chains provide a sample from the distribution of each of the time-varying parameters, enabling a rich analysis environment. The MCMC estimation results in a range of values obtained through different samples from many different chains. Note that each parameter for each period is estimated using a sample from a chain. Given time varying nature of the parameters, one needs a way to compare between different time periods. Each parameter in each interval comes as a sample from many different chains as a result of the estimation. Using differences in constructing the Y vector in Equation (1) helps to focus on the effect of changes, controls for spurious effects and is helpful for obtaining stationarity. The following statement provides a formal brand health definition:

Statement regarding brand health: Let the Y vector in Equation (1) be constructed by the differences and the first row represent the market share. β_{1,t} and α_{1,k,t} represent the first row of the vector B_{t|t-1} and matrix A_{t|t-1} in Equation (1). Then the brand health at time t (Hₜ) is defined by:

$${H}_{t} = \frac{\vert {β}_{l , t} \vert + {\sum }_{k = 2}^{K} \vert {α}_{1 , k , t} \vert}{\text{?}} \qquad ( 8 )$$

$$\text{?} \text{indicates text missing or illegible when filed}$$

where |⋅| represents the norm,

$$\text{?} \qquad ( 9 )$$

$$and ,$$

$${\overline{α}}_{1. k . t} = \frac{1}{M} {\sum }_{m = 1}^{M} {α}_{1 , k , t , m} \qquad ( 10 )$$

$${\overline{σ}}_{1 , k , t}^{2} = \frac{1}{M} {\sum }_{m = 1}^{M} {( {α}_{1 , k , t , m} - {\overline{α}}_{1 , k , t , m} )}^{2} \qquad ( 11 )$$

$$\text{?} \text{indicates text missing or illegible when filed}$$

wherein m represents a chain obtained from MCMC, for m=1 . . . M; k=1 . . . K; t=1 . . . T;

To understand the above statement, given the observations in t-1, represented by reference number 1 in FIG. 2, and based on equations (4) and (5), consider the expected market share change at time t:

$$\text{?} \qquad ( 12 )$$

$$\text{?} \text{indicates text missing or illegible when filed}$$

Given the autoregressive term in Equation (12), the long-term market share impact that can be attributed to the (filtered) coefficients at time t is:

$$\text{?} \qquad ( 13 )$$

$$\text{?} \text{indicates text missing or illegible when filed}$$

Equation (13) states that the sum of the long-term impacts on market share changes that can be attributed to the coefficients and Y_{k,t-1}*, k=2 . . . K is

$$\frac{\sum α \text{?}}{1 - α \text{?}}$$

$$\text{?} \text{indicates text missing or illegible when filed}$$

The period specific unobserved variables impact is

$$\text{?}$$

$$\text{?} \text{indicates text missing or illegible when filed}$$

At unit increases for Y_{k,t-1}* and using normalized values for the coefficients, t instead of t|t, Equation (8) is obtained. Using normalized values provides a measure of the relative importance of the variables. Higher variations suggest lower signal quality. The empirical case study below shows that normalization provides a parsimony (efficiency and effectiveness) and more meaningful metrics when comparing time-varying parameters. Essentially, Equation (8) captures the ability to gain market share. Note that in cases wherein the brands are well-established and mature, most of the market share moves can be explained via the changes in trade and distribution support or perceptions, including the ones associated with product quality. They are an end result of user perceptions and communications and Equation (8) is suitable for this purpose.

In identifying the above parameters, Equation (1) controls for many other factors. For example, consider the case where post consumption, users produce contents. Then, market share will drive Mindshare since a consumption should occur first before creating the contents. If Mindshare represents the second row in Y, this effect will be in α_{2,1}. Further, these effects differ across periods and brands.

A presentation of this filtering mechanism is also shown in FIG. 2. FIG. 2 considers a point starting from t. Given the coefficient in I_{t|t-1} represented by reference number 5 in FIG. 2 and coefficients Mindshare, Brand Affinity and price represented by reference number 6 in FIG. 2, equations (4) and (5) are used to find the expected market share Y_{t|t-1} represented by reference number 7 in FIG. 2. At the end of the period t, market share is realized (Yₜ*), as seen by reference number 8 in FIG. 2. Based on the difference (Yₜ*−Y_{t|t-1}) represented by reference number 9 in FIG. 2 and using equations (6) and (7), I_{t|t} is filtered at reference number 10 in FIG. 2. Using the filtered values, the brand health is calculated according to Equation (8). Similar dynamic structures are used for capturing consumer learning and brand valuation.

There may be other ways to specify the model in Equations (1) and (2), such as allowing for stochastic variance-covariance matrix, allowing for higher order lags and or contemporaneous effects. The estimation results show that the main insights of the model do not change with different model specifications. Another idea may be to use impulse response functions for defining brand health instead of Equation (8). But, given the time varying nature of the estimates, such an approach does not provide fruitful outcomes and cannot properly account for the changing uncertainty of the estimates across different time periods, resulting in losing the diagnostic ability of the model and adding additional complexity. Finally, one other approach may include normalizing after calculating the time specific brand health values using the chains. This does not provide a more meaningful approach as different parameters may have different scales and a certain parameter's response changes across the periods may dominate all other response parameters' changes, hiding the potential health improvements. Hence, the present invention's model of brand health above, as represented by Equation (8), provides a robust yet parsimonious (effective and efficient) structure for the dataset.

### Empirical Case Study

### Part I: Data

The inventor has utilized the present invention's model of brand health, as represented by Equation (8) above, on an empirical case study wherein the model has empirically proven its robustness, effectiveness, and efficiency.

The inventor utilized a dataset comprising three market leading brands, all in alcoholic beverages: one spirit (Brand A) and two beers (Brand B and Brand C), competing in the same geography. The data include monthly volume market shares and per liter prices as an index for 90 months. The beer brands B and C had majority of sales coming from self-service purchase locations. The situation is reversed for spirit Brand A wherein the majority of sales for Brand A resulting from trade (i.e, restaurants, bars, entertainment locations that require a service) represented a significant weight in sales.

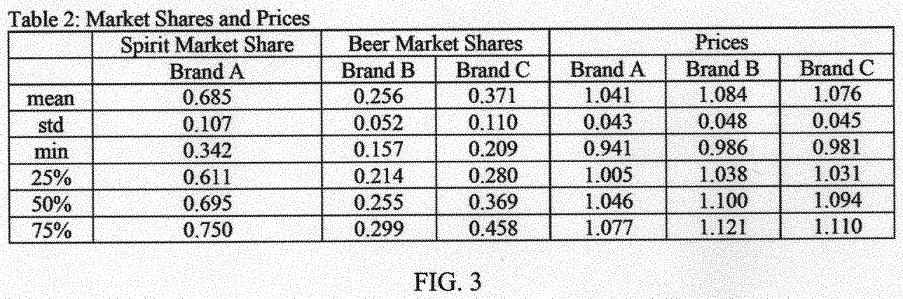

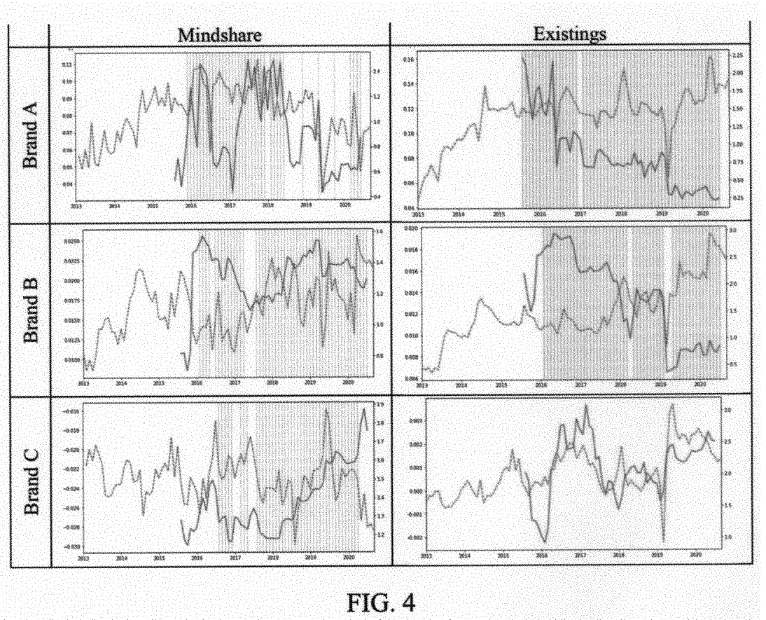

Although an exact percentage is not available, user generated content distribution parallels the importance of trade or open channel for spirit brand A and off-trade or closed channel for beer Brands B and C. All three brands' market shares are given in FIG. 3's Table 2 whereas FIG. 4 shows the changes across time. As can be seen in FIG. 3's Table 2, Brand A keeps its market share high till 2018. Lately, however, Brand A has been losing market share. As can be further seen in FIG. 3's Table 2, Brand B begins with a small market share at the beginning, before steadily increasing the market share. Brand C, as can be seen in FIG. 3's Table 2, continuously loses market share throughout the observation period.

FIG. 3's Table 2 and FIG. 4 also provide price descriptives and trends, respectively. Prices are adjusted for alcoholic content degree to account for higher alcohol content for the spirit Brand A (40%) versus the beer brands B and C (5%). This is a common practice to those of ordinary skill in the art to compare different brands with different alcoholic content degrees. None of the brands change their alcoholic content during the observation period. Prices are steady although the price for the spirit Brand A decreased around 2014 and in general stayed lower compared to other brands. There was approximately a 15% price jump in the market across the spectrum between 2014 to 2016 but stayed relatively flat for the beers. Market share gaining beer brand, Brand B, has higher prices throughout compared to beer Brand C. Given the nature of the sector, for the major established brands in general, as is the case for the brands in the dataset, the prices tend to move in tandem and sustainable price related market share gains or losses are not observed.

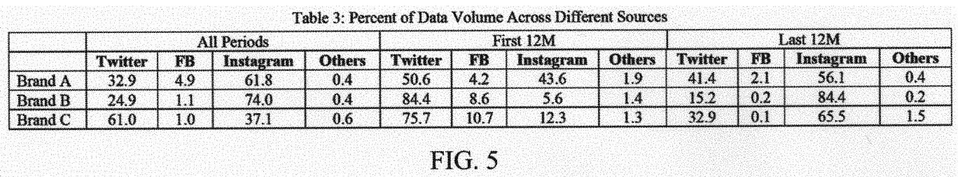

It is noted that the Alcoholic Beverage market is regulated and no advertising is allowed in any platform. Social media provides an environment wherein brands may engage in significant social-based campaigns using hashtags, events, concerts, festivals, and/or influencers, among other factors. Various hashtags, events, concerts, executions, use of influencers and contents in general define different advertising campaigns for each of the respective brands. Brands use all social media and monitor publicly available sources from various social media websites (INSTAGRAM, FACEBOOK, TWITTER, etc.), blogs, discussion boards, applications, and review/rating websites and applications. A breakdown of such volume across different sources is given in FIG. 5's Table 3. As can be seen in FIG. 5's Table 3, the initial dominance of TWITTER has been replaced by use of INSTAGRAM lately.

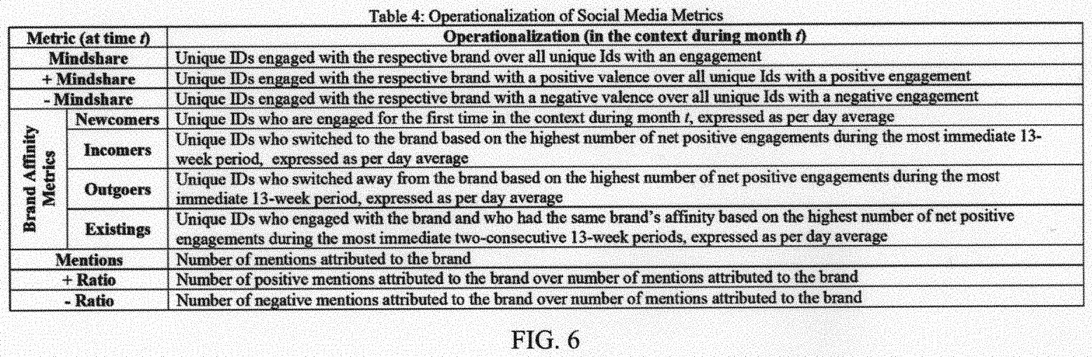

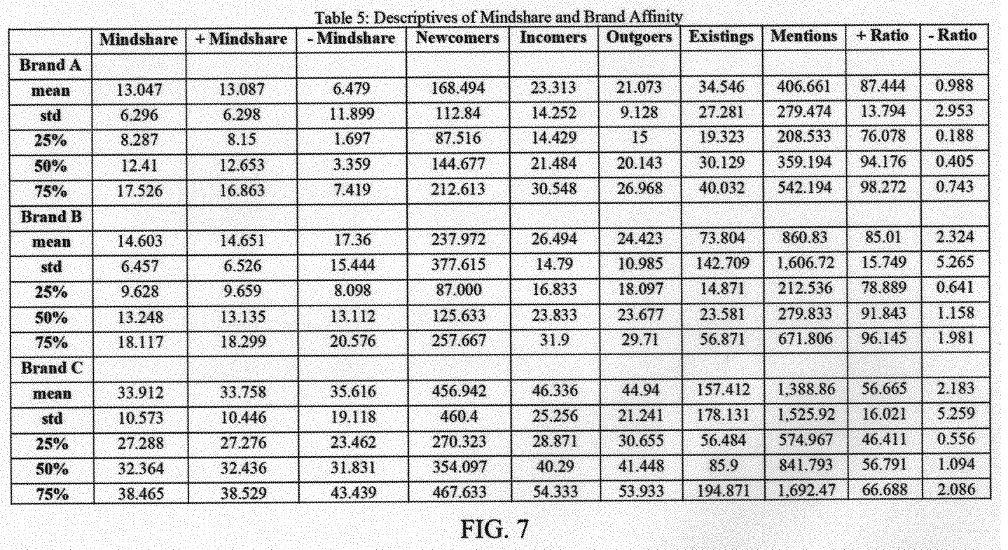

Social media metrics use all the available sources. Mindshare is calculated by using the unique IDs who engage with a brand during the period. It is noted that IDs are the social media accounts or handles. Different social media accounts or handles are treated as separate IDs. The engagement may include a retweet, like, comment, post, etc. For example, if there are 1000 Unique IDs engaged with the alcoholic beverage sector during the period, a 10% Mindshare means 100 Unique IDs engaged with the respective brand. As to this case study, Brand A's average Mindshare is 13.05%, Brand B's average Mindshare is 14.60%, and Brand C's average Mindshare is 33.91%. These Mindshares are calculated across all alcoholic beverages. Note that an ID that engages with multiple alcoholic beverage brands is calculated as part of the Mindshare of all the respective brands that the engagement occurs. Thus, due to the nature of Mindshare calculations, given a specific month, the sum of all alcoholic beverage brands Mindshares may be greater than one. This way of calculating Mindshare opens up the potential to consider all consumers who are active and interested in alcoholic beverages. No matter whether the brand is a spirit (Brand A) or a beer (Brand B or Brand C), the target audience becomes any consumer who is interested in adult beverages. A category leading brand, such as brand A, can target any consumer in this market. Operationalization of social media metrics are provided in FIG. 6's Table 4 while their respective descriptives are provided in FIG. 7's Table 5.

Moreover, the present invention further extends the Mindshare definition to include sentiments with positive (+) Mindshare and negative (−) Mindshare. The positive Mindshare metric is obtained via the ratio of unique authors who provide positive mentions about the respective brand over all the unique authors active in the sector who produce positive contents during a given period. Conversely, the negative Mindshare metric is obtained via the ratio of unique authors who provide negative mentions about the respective brand over all the unique authors active in the sector who produce negative contents during a given period. In FIG. 7's Table 5, positive Mindshare levels are very similar to Mindshare levels for all brands.

Brand affinity metrics are based on the observed social media behavior of the IDs. An ID that produces the most positive and or neutral and frequent content about a brand within the last quarter (13 weeks) is said to have the brand's affinity. This window is set based on the consumer insight professionals' inputs from the respective alcoholic beverage companies. There are different types of brand affinities: Newcomers, Incomers, Outgoers and Existings. Brands may expand the number of IDs and reach new ones, the ones who never discussed the brands before. Consequently, brands bring in new IDs engaging in the context for the first time, these are Newcomers. FIG. 7's Table 5 shows that Brand A has the ability to acquire 168 new IDs/day (and expand the sector) whereas Brands B and C fare 238 and 457 Newcomers per day, respectively.

Outgoers of a brand represent the IDs who used to engage positively the most with respect to other brands but switched to engaging positively the most to a different alcoholic beverage brand. On average per month, for brand A, there are 21 outgoers per day, and for brands B and C, 24 and 45 outgoers per day respective, as seen in FIG. 7's Table 5. Incomers are the opposite of outgoers. These are the IDs who previously had a competing brand affinity but now, switched to the respective brand. There are 23, 26 and 46 such IDs per day for brands A, B and C, respectively.

Existings are the IDs that already have a brand's affinity. For example, when IDs that already have a Brand's Affinity from the past quarter engages with the brand in a given month (and without changing his/her Brand Affinity), that ID is classified as an ID with an Existing affinity. Existings per day engaging with brands A, B and C are 35, 74 and 157, respectively.

Mentions represent the average number of times the brand is mentioned per day. The most mentioned brand is brand C, with 1389 mentioned times per day. Brands B and A mentions per day are 861 and 407, respectively. A Negative Ratio represents the negative valence within the brand-specific contents. If there are 100 contents specific to a brand, a 10% negative ratio means there are 10 negative contents that include the brand. Positive contents mean users provide positive emotion while mentioning a brand or its assets, be it a hashtag, social media account(s), owned keyword(s), event(s) and/or campaign(s). Neutral contents are the ones that only share factual information with no specific emotion towards the brands. In general, given the nature of the sector, positive sentiment is more likely and negative contents are limited. Brand A has a 1% negative ratio whereas brands B and C each have a 2% negative ratio. For brands A and B, the positive ratio is close to 90%. It is noted that the beer brand C engages in significant sponsorships. Unless a specific sentiment towards drinking the beer brand is used, these contents are classified as neutral. That is the reason why Brand C has a significantly lower positive ratio. (Using a positive and neutral ratio is the same as 1 negative ratio, as the results do not change.)

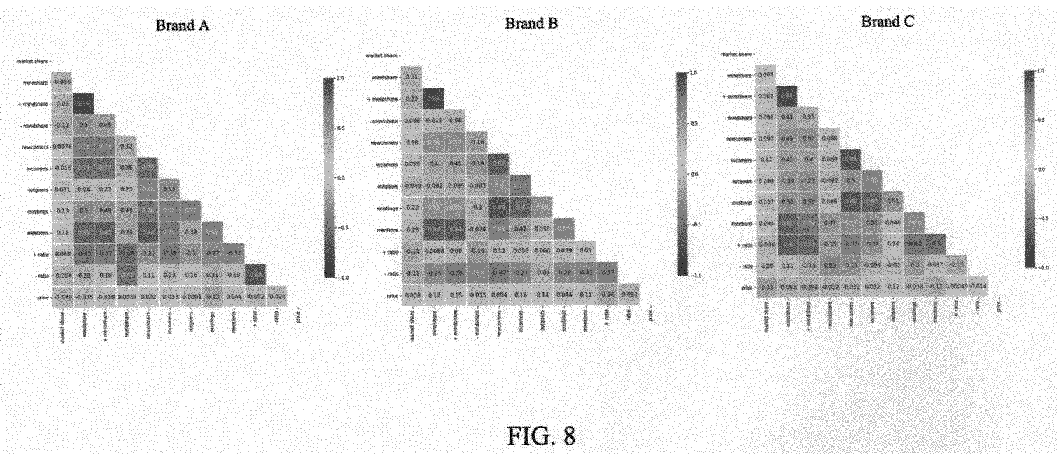

Differenced market shares pass the stationarity test, meaning that without differencing, in levels, the market shares are not stationary since the minimum differencing needed for stational is 1. Moreover, Augmented Dickey-Fuller (ADF) test statistics for market shares for each of brands A, B and C are −7.298, −12.316 and −6.572, respectively. Also, the Critical Value (1%) is −3.507 and all tests are highly significant. Correlations of the log-differenced data per brand are given in FIG. 8. Log-differencing also helps to deal with scale differences of variables.

Looking at the overall correlations across brands, Mindshare is significantly correlated with positive Mindshare and mentions. Although for Brand A, Mindshare is highly correlated with Newcomers and Incomers, this is not the case for Brands B and C. This may be due to the strong dominant role Brand A has in its market. Across brands, negative mindshare and negative ratio are also correlated as they are 0.8, 0.6 and 0.5 for Brands A, B and C, respectively. There are also positive and significant correlations between Newcomers, Existings and Incomers across all the brands. For Brand A, Newcomers and mentions are also highly correlated, as correlation is 0.8.

### Part II: Analysis and Results

An initial investigation checks whether and how the proposed parameters affect the market share, thereby testing the previously mentioned Statement 1 and Statement 2. Indeed, the results show that both statements hold and that the most influential metrics are Mindshare and Existings. Henceforth, the present invention will delve into the brand-health model. Consider the econometric model presented in Equations (1) and (2) above. The Y vector includes Market Share (MS), Mindshare (MiS), Existings (E) and Price (P). Equation (1), suppressing subscript b, becomes:

$$[ \begin{matrix}MS \\ MiS \\ E \\ P\end{matrix} ] = \text{?} \qquad ( 14 )$$

$$\text{?} \text{indicates text missing or illegible when filed}$$

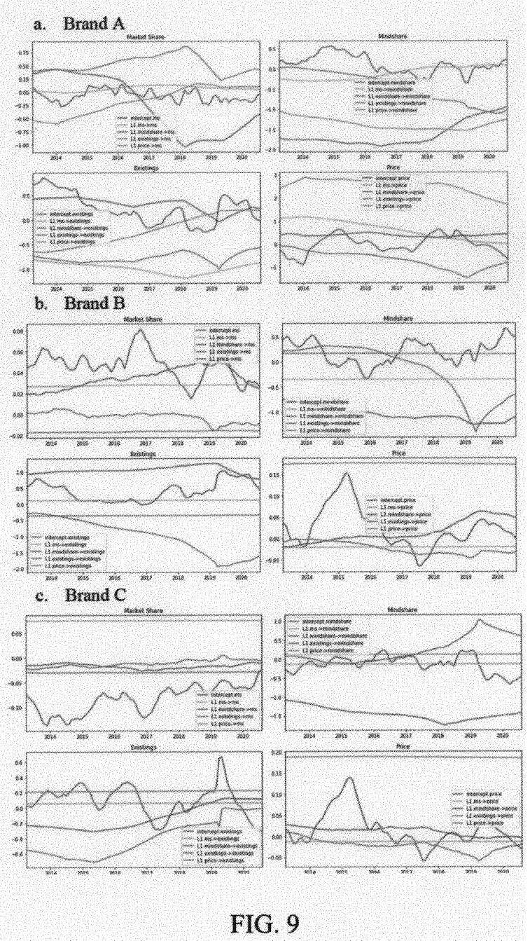

Equation (14) provides the operationalization of Equation (1), resulting in [Y]_{4×1}, [B]_{4×1}, and [A]_{4×4}, and the coefficients, I in Equation (3), a 20×1 vector. Essentially, starting with uninformative priors, the samples are drawn consecutively from marginal distributions iteratively. The estimation results in a sample consisting of many different samples obtained from different chains of all the parameters. The MCMC chains converge quickly and behave as expected, all staying in an interval with no trends detected. Still, the MCMC chains are run for 200,000 iterations. The initial 100K is used as burn in. The last 100K is used for analysis. The estimation is done both in Python and MATLAB and they both provide similar results (MATLAB produces the results 30% faster than Python). The samples are taken from every 40th draws in a chain to break potential dependencies in between the draws. Resulting sample for each variable includes 2,500 observations for each time period. The normalized estimates are presented in FIG. 9. The estimates for each respective equation are given in a separate frame. Equation (14) shows that each equation has five coefficients to estimate, including intercept. The five different lines in each frame in FIG. 9 represent these coefficients.

For Brand A, Market Share's intercept shows a rather stable reading and stays close to zero, the blue line (intercept→ms) represents β_{MS} in Equation (14), as seen in FIG. 9. When considering Brand B and Brand C, the market share intercepts significantly vary across the horizon in FIG. 9. For Brand B, it starts high but decreases during the second half. For Brand C, the intercept is the most negative term for market share, although it increases towards zero in time. In general, the auto-regressive terms are also rather stable, see the orange lines in Market Share frames in FIG. 9 (L1 ms→ms).

Mindshare shows a dramatic change from positive to negative for Brand A. α_{MiS,MS} in Equation (14) is represented by the green line (L1 mindshare→ms) under Market Share frames, as seen in FIG. 9. For Brand B, it increases till 2019 and decreases afterwards, always staying above zero. For Brand C, α_{MiS,MS} is rather stable around zero, showing a very limited impact. The red lines in FIG. 9 for the market share equation (L1 existings→ms) represent the α_{E, MS} in Equation (14). For Brand A, it increases till 2018 and decreases later. For Brands B and C, the red lines are rather stable around zero. Finally, for price, α_{P, MS} is represented by the purple lines (L1 price→ms) under the Market Share titled frames, the lines are rather stable, negative to neutral for Brands B and C. For Brand A, it starts from a negative reading and increases till 2018, achieving a stable neutral reading.

The readings so far suggest negative coefficient readings for Brand C and positive readings for Brand B. For Brand B, the positive intercept is followed by the higher impact of Mindshare around 2017. For Brand A, a pre-2017 positive picture dominated with Mindshare and Existings turned into a rather negative picture by a strong move of Mindshare towards negative.

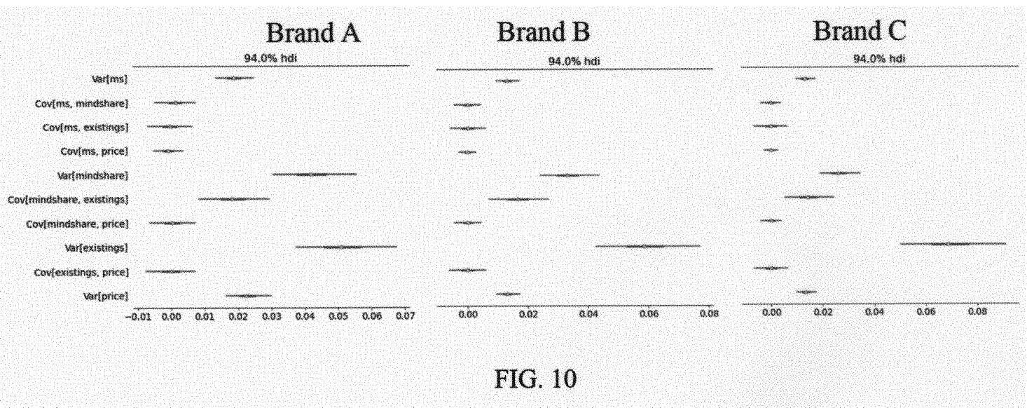

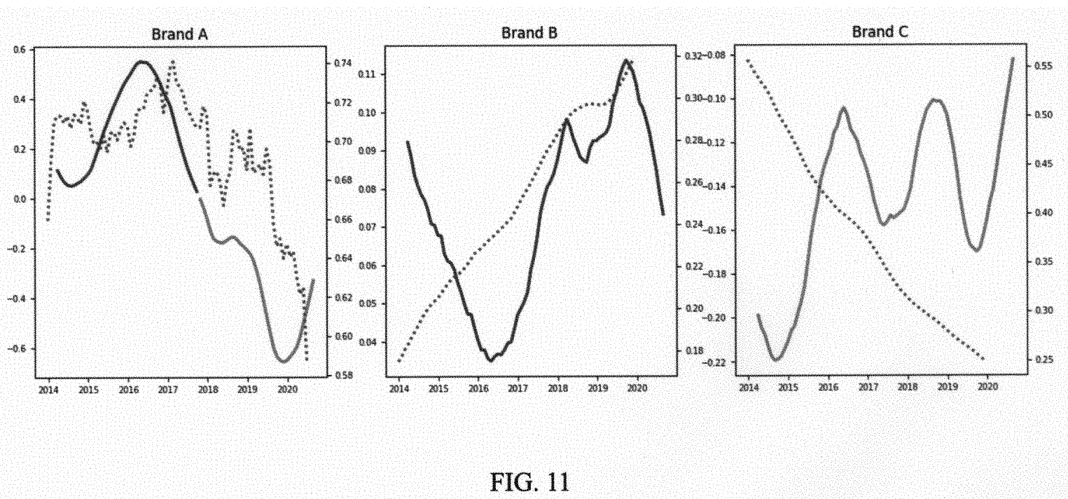

Moreover, the variance-covariance terms are given in FIG. 10. The most negative readings are achieved between price and Existings. Mindshare and Existings covariances are rather positive. Using the obtained samples, the operationalization for brand health results in:

$$\text{?} \qquad ( 15 )$$

$$\text{?} \text{indicates text missing or illegible when filed}$$

where |⋅| represents the norm operator defined in Equation (9). Resulting brand healths are given in FIG. 11. The green lines represent health and positive Hₜ values whereas the red lines represent negative Hₜ values. The corresponding market shares are given as dotted lines.

In FIG. 11, Brand A starts with a healthy status as the health is positive, indicating the ability to gain market share. Indeed, the market shares stay strong and peak in 2017. Afterwards, the health deteriorates and turns red eventually, suggesting an inability to gain market share. Brand B health remains strong with a green status. Brand C health is the opposite and remains red. Although after 2018, a trend upwards is seen, the level stays below zero and the market share loss continues, albeit at a lower rate.

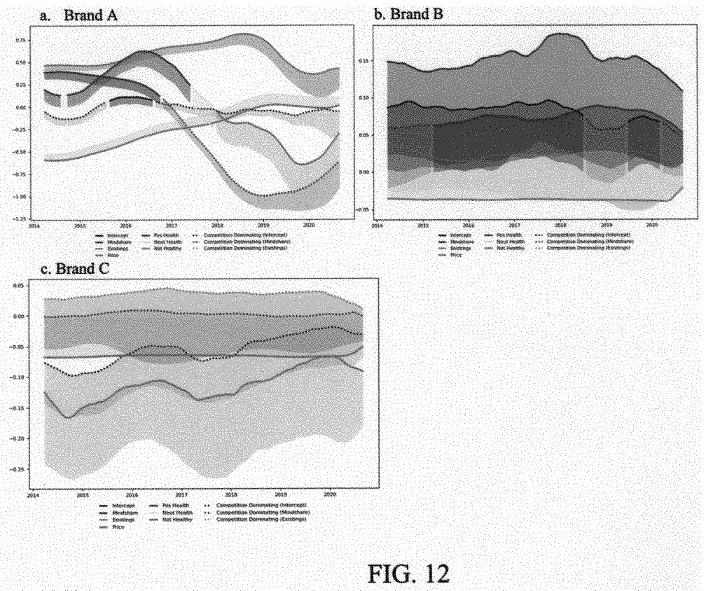

Essentially, the brand healths and the underlying model as presented in Equations (1) and (2) help to extract the signals on the ability to gain market shares. As a reliability check, one can re-estimate the model by masking the last periods and looking back at the past values. Thus, by discarding the last months, the model is re-estimated a number of times. As an example, going back twelve months, such an analysis is done twelve times iteratively, each time, by discarding the last month and re-estimating the model. The analysis, then, yields a range of values for each period, essentially creating strips rather than lines, showing the maximum and minimum values for each month obtained by these different estimates. These strips are provided in FIG. 12 and represent different brands for the focal parameters of interest.

In FIG. 12, when all the values in the strip are positive, a line is drawn at the upper region of the strip. When the values fall in negative territory, the line becomes dotted. The health is green when all values in the strip is positive, it is yellow when some values are negative and it is red when all values are negative. FIG. 12 shows that findings are rather robust. Although the strips become wider and narrower representing the different values obtained through different estimates, the trends and positive/negative ranges are consistent. As seen in FIG. 12, Brand A's health decreases, Brand B keeps its health and Brand C stays in the negative territory, although a positive trend is apparent after 2017.

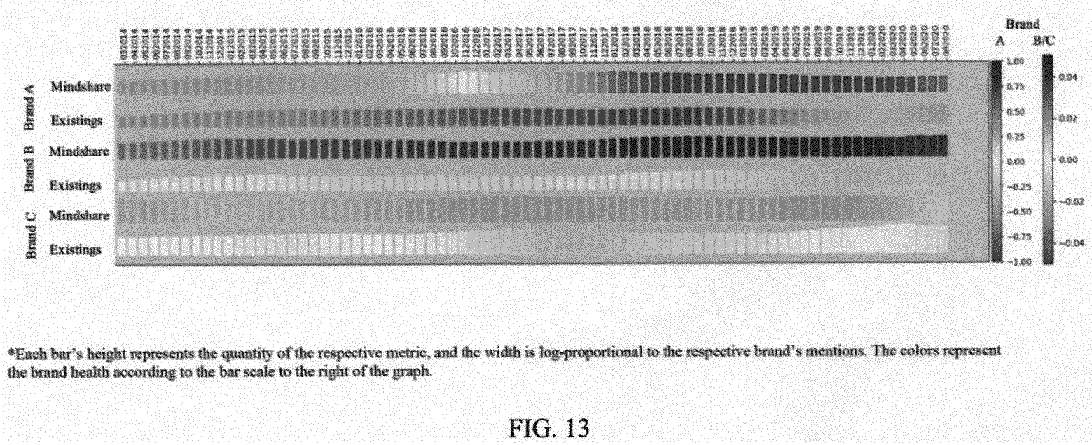

FIG. 13 shows the observed contents and their effects on health. For each brand-variable pair, the rectangles represent the size of the observations for each month. The rectangle's width is (log) proportional to the observed volume and the height is proportional to the respective variable's value. For example, as seen in FIG. 13, for Brand A Mindshare under a given month, the rectangle's width is proportional to the Brand A's mention count and the height is proportional to Brand A's Mindshare. As can be also seen in FIG. 13, for Brand A Existings the width is proportional to the Brand A's mention count and the height is proportional to the Brand A Existings value. Moreover, FIG. 13's rectangle colors represent the health effects. The green is for positive coefficients. The color intensity is proportional to the coefficients for Brands A, B, and C. The average values obtained from the previous analysis (i.e., FIG. 12) are used for the coefficient values associated with Mindshare and Existings. FIG. 13 shows that there are distinctively different periods depending on the brand health. FIG. 13 and the underlying data enable rectifying options to identify exactly which campaign, meme and/or source (i.e., influencer) contribute to the changes in brand health. After which, the brand managers may rectify these factors and/or source accordingly thereby improving brand health. A learning from FIG. 13 is that volume does not necessarily drive the brand health effects. Indeed, the present invention's brand health model will recommend the halt of using social mention counts as an indicator of Brand C's performance.

### Part III: Summary, Discussion, and Conclusion

Recent developments have accelerated the pace of disruptions as information systems in general such as Information Communication Technologies (ICT), social media and digital systems become dominant sources of competitive advantages in marketplaces and economies. As brand managers are increasingly torn between last-click oriented technology firms and increasingly fiddle consumers in the face of exponential innovation in the marketplace, creating and measuring meaning, relevance, and the consumer-brand connection provide important challenges. The present invention provides a solution in the form of a novel brand health model for measuring brand health based on social media and an accompanying decision support system. The proposed brand health model uses a time-varying parameter vector auto regression structure providing a flexible methodology to allow for changing market responses. From a model selection point of view, although fixed response parameters may provide a parsimony, the empirical results suggest that the time-varying parameters are indeed meaningful with important health signals.

The proposed Mindshare and Brand Affinity metrics have the ability to capture customer behavior based on the observed user generated contents on social media. In fact, the metrics are calculated based on individual-level panel observations on social media and are not subject to many of the biased surveys or traditional discrete intervention-based approaches have, thus providing a “God's eye-view” information. Further the metrics allow for the incorporation of dynamics sets of data such as viral memes. All the engagements the brands attain define the customers' attention pool wherein the customers' attention pool is known as a context. Just as considering all the alternatives a consumer faces when looking at the shelves in a supermarket is essential, considering all alternative brands in the market that consumers may be exposed to in social media is important in creating the sales explaining metrics. This context provides a basis to calculate the social media metrics and is fixed and the same for the brands unless new competitors, hashtags or events are introduced. Given a context, it becomes possible to define Mindshare and Existings metrics, which are crucial in explaining market shares and defining brand health. Mindshare provides the penetration of the brand in the attention pool set by the context. Recall that the Mindshare metric is calculated by dividing the number of unique authors or social media IDs who engage with a brand by the number of all IDs who engage in the context. The engagement may include a retweet, like, comment, post, etc. involving a brand-related asset (name, hashtags, campaigns, etc.).

Based on all the engagements a consumer has with all the brands in a given context, it is possible to define the relative importance of a brand. An author that produces the most frequent positive/neutral content about a brand when compared to the brand's competitive set in the sector is said to have the specific brand's affinity. Brand affinities may continue to be the same for an author if the author continuously engages with the same brand the most positive in the context. If the author continuously engages more with the same brand compared to all the other brands, this author is called an author with the specific brand's affinity.

In the model, linking these metrics with market share as a product-market performance indicator enables creating a brand health metric. A special power of the proposed brand health metric is its ability to bypass rather abstract constructs in customer mindset (i.e., brand equity) and provide a measurable, yet simple link between customer behavior and market performance which can be incorporated within an information systems infrastructure. Using market shares provides double jeopardy since higher market shares are associated with higher repeat-buying and simultaneously capture relative popularities of brands. The present invention statistically links market share with customer mindset and observable behavior metrics and calls the strength of this link the brand health. Accordingly, healthy brands gain market share with communications.

There are plenty of model-free evidence showing the strength of the proposed brand health model. Mindshare provides a quantitative content-related measure. In the model, Mindshare measures the penetration of brand related communications' engagements in the context. A higher level indicates a higher awareness and/or interest. Having a higher level of Mindshare does not necessarily lead to the same level of sales impacts across different time periods. That is why one needs mindshare-based sales performance metrics. This can provide a basis for a brand scorecard as a performance measure as part of an ICT. Essentially, the sales elasticities of the generated content provide the brand managers with a quality measure. If the generated contents provide higher sales elasticities, then, it means that the content's quality (sales impact) has increased. For Brand A's case, it can be sees that both Mindshare and its sales elasticities have been decreasing as a long-term trend. In fact, this decrease has been joined with Existings sales elasticity decreases. This suggests that the product perception and satisfaction has been an increasingly important problem which signifies that satisfaction and quality perception related problems have been an issue given aggressive new product introductions by competitors. In accordance with the present invention's brand health model, a Mindshare increase accompanied by a joint increase in Existings elasticities may provide a strategy to generate positive improve on product satisfaction for Brand A.

When it comes to specific campaign questions, for example lottery effectiveness, the answer depends on idiosyncrasies of the campaign, coupled with the state of brand health. Based on the experience so far, one can say that lotteries have been initially very effective for Brand B but have been losing their effectiveness lately. Meanwhile lotteries have not been effective for Brand C at all. The answer is obvious when one observes the present invention's brand-health models. Brand B has positive Mindshare & Existings elasticities while Brand C has low elasticities. In addition, Brand B has a healthy brand while Brand C does not. The trick is first to improve on the image and product by gaining the support of Existings and lighting their fire. Then, communicating this increase in product quality and satisfaction with higher Mindshare. Without satisfaction, MindShare's impact wanes thereby gradually decreasing the elasticities. This has been the case with Brand A. More recently, Brand C has worked on the product and gained a significant satisfaction advantage. Then, through Mindshare, the brand can gain market share.

There are risks associated with technology and social media. Similar to machines learning to optimize tasks, people are also optimizing the ways to acquire followers or gain social capital. Reputation management is especially becoming a challenge as deep fake technologies have the potential to exploit many of the human vulnerabilities. The approaches and metrics suggested in this present invention's brand health model can signal the points in time when certain developments take an effect on brand market shares. By zeroing in on the contents and the actual posts, the present invention's brand health model can help identify the influential authors and/or posts and thereafter rectify accordingly.

Without a robust understanding of the current state of brand, there is no value in what-if simulations for the future. The objective of the present invention's brand health model is to follow a signal extraction approach to measure a brand's success in generating market share using the state-of-the-art information systems, social media, and appropriate data metrics. The present invention's brand health model can be estimated for different channels provided the data exists. Furthermore, using higher frequency metrics may also be possible for the present invention's brand health model. It is noted that the above is merely an empirical case study in which the present invention's brand health model has empirically proven its robustness, effectiveness, and efficiency. The present invention's brand health model may be replicated across various markets for various products; moreover, the brand health model may be applicable to markets with more or less detailed metrics, as need be.

### Measuring Brand Health

As such, it has been established that FIG. 1 is a representation of a method of measuring a brand health of a brand wherein a series of coefficients or higher coefficients suggest increasing brand health. As seen in FIG. 1, such real-time coefficients include the aforementioned Mindshare metrics, brand affinity metrics, price of the brand, and period-specific unobservable impacts. Moreover, it has been shown that Equation (1) is an analytical representation of the invention's current model wherein a calculation of the market share Y is arrived at, in real-time, via the use of the coefficients: Mindshare, brand affinity, variables of interest, and period-specific unobservable impacts. Furthermore, as explained above via the relevant equations, FIG. 2 represents the arrival at the said coefficients via the appropriate filtering mechanism. Subsequently, the present invention discloses the arrival at and the measuring of the brand health Hₜ in real-time, as seen in Equation (8). Thereafter, the present invention discloses the allocating, based on the brand health Hₜ of the brand, marketing resources for the brand wherein such marketing resources may include media buying, campaign spending, marketing expenditures, product modifications, product pricing, experimenting with various marketing campaigns, stimulating the impact of increasing budget on current marketing campaigns, increasing the budget(s) on current marketing campaigns, and/or simulating the impact of increasing the budgets(s) on current marketing campaigns through buying more mindshare and/or media/influencer spending. Alternatively, the present invention discloses a decisions support system based on the calculated brand health Hₜ or the supporting, based on the brand health Hₜ of the brand, decisions to improve the brand health of the brand wherein such decisions may include continuing to spend more, less, or pivoting marketing campaigns accordingly, identifying product designs, identifying product formulations, experimenting with different brand positioning statements, coming up with new customer value propositions, and/or simulating different and/or various scenarios to see the resulting marketing share into the future.

Hereinafter, a discussion will commence as to how the aforementioned real-time coefficients/parameters (Mindshare, brand affinity, price of the brand, and period-specific unobservable impacts) are gathered, calculated, and determined so as to arrive at the brand's market share Y and, thereafter, its brand health Hₜ, and, subsequently, allowing for marketing resources allocation and/or decisions support system based on the arrived-at brand health Hₜ.

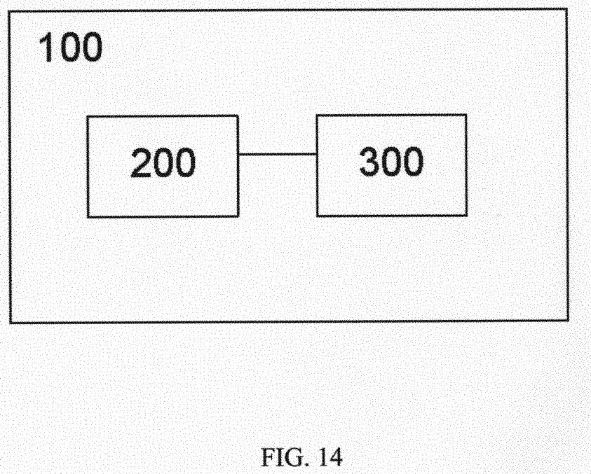

FIG. 14 illustrates at least one device 100 in which a method and system for measuring the brand health Hₜ of the brand in real-time and the subsequent marketing resources allocation and/or decisions support system based on the arrived-at brand health Hₜ may be implemented. However, it should be appreciated that the systems and methods described below are not limited to use with the particular exemplary device 100 shown in FIG. 14 but may be extended to a wide variety of implementations. For example, the method and system for measuring the brand health Hₜ of the brand in real-time and the subsequent marketing resources allocation and/or decisions support system based on the arrived-at brand health Hₜ may be implemented via big-data cloud computing infrastructure. As shown in FIG. 14, the device 100 may include a processor 200 and a memory device 300.

By utilizing the at least one device 100 having a processor 200 and a memory device 300, the present invention's method and system measures the brand health Hₜ of the brand in real-time through the obtaining of social media metrics via the obtaining of unique IDs, the determining of the set of the aforementioned coefficients, the subsequent calculating of the market share Y of the brand via the use of the coefficients, and the ensuing calculation of brand health Hₜ of the brand in real-time via the use of both the market share Y of the brand and the aforementioned coefficients. Thereafter, the present invention's method and systems discloses the allocating, based on the brand health Hₜ of the brand, marketing resources for the brand wherein such marketing resources may include media buying, campaign spending, marketing expenditures, product modifications, and/or product pricing. Alternatively, the present invention discloses a decisions support system based on the calculated brand health Hₜ or the supporting, based on the brand health Hₜ of the brand, decisions to improve the brand health of the brand wherein such decisions may include continuing to spend more, less, or pivoting marketing campaigns accordingly, identifying product designs, identifying product formulations, experimenting with different brand positioning statements, coming up with new customer value propositions, and/or simulating different and/or various scenarios to see the resulting marketing share into the future.

Initially, the method and system of the present invention utilizes the at least one device 100 to obtain social media metrics from available sources. Such gathering and obtaining of social media metrics is done via the obtaining of unique IDs who engage in various forms with all the relevant brands in the context, both the brand in question and its competing brands. The unique IDs are all social media accounts or handles, across all pertinent platforms. Different social media accounts or handles are treated as separate unique IDs. Moreover, the aforementioned engagement may include any pertinent online engagement such as a retweet, like, comment, post, etc.

In order to calculate Mindshare metrics, the at least one device 100 obtains the unique IDs who engage with the brand during the pertinent period of time. Thereafter, the at least one device 100 calculates Mindshare metrics by dividing a number of unique IDs who engage with the brand over a number of unique IDs that that engage with both the brand and the competing brands in the context and/or market. If, for example, there are 1000 unique IDs engaged with the brand during the period, then a 10% Mindshare means 100 unique IDs engaged with the respective brand.

Note that a unique ID that engages with multiple brands may be calculated as part of the Mindshare of all the respective brands (both the brand and the competing brands) that the engagement occurs. Thus, due to the nature of Mindshare calculations, given a specific month, the sum of all the Mindshares of all the brands in the context (both the brand and the competing brands) may be greater than one. This way of calculating Mindshare opens up the potential to consider all consumers who are active and interested in the appropriate context of the brands. No matter whether the brand is a Brand A or Brand B, the target audience becomes any consumer who is interested in the pertinent context or market of the brands. As such, a category leading brand may target any consumer in this market.

In order to specifically calculate positive mindshare, the device 100 aggregates positive content(s) or positive engagement(s). Thereafter, the device 100 calculates positive mindshare by dividing a number of unique IDs who generated positive content(s) or positive engagement(s) when engaging with the brand by a number of the unique IDs who generated positive content(s) or positive engagement(s) when engaging with all the brands (both the brand and the competing brands) in a given period. Similarly, in order to specifically calculate negative mindshare, the device 100 aggregates negative content(s) or negative engagement(s). Thereafter, the device 100 calculates negative mindshare by dividing a number of unique IDs who generated negative content(s) or negative engagement(s) when engaging with the brand by a number of unique IDs who generated negative content(s) or negative engagement(s) when engaging with all the brands (both the brand and the competing brands) in a given period.

The aforementioned positive content(s) and/or positive engagement(s) refers to authors, users, and/or unique IDs who provide and/or share positive emotion while mentioning a brand or its asset, be it a hashtag, social media account(s), owned keyword(s), status(s), story(s), event(s) and/or campaign(s). Positive Ratio represents the positive valence within the brand-specific contents. If there are 100 contents specific to a brand, a 10% positive ratio means there are 10 positive contents and/or positive engagement(s) that include the brand. The aforementioned negative content(s) and/or negative engagement(s) refers to authors, users, and/or unique IDs who provide and/or share negative emotion while mentioning a brand or its asset, be it a hashtag, social media account(s), owned keyword(s), status(s), story(s), event(s) and/or campaign(s). Negative Ratio represents the negative valence within the brand-specific contents. If there are 100 contents specific to a brand, a 10% negative ratio means there are 10 negative contents and/or negative engagement(s) that include the brand. Neutral content(s) and/or neutral engagement(s) refers to authors, users, and/or unique IDs who provide or share only factual information vis a vis the brand(s) with no specific emotion towards the brand(s) while mentioning a brand or its asset, be it a hashtag, social media account(s), owned keyword(s), status(s), story(s), event(s) and/or campaign(s).

It has been previously mentioned that the set of coefficients pertinent to determining brand health H₁ comprise (but are not limited to): mindshare metrics, brand affinity metrics, other variables of interest, and period-specific unobservable impacts. It has been noted that the determining and calculation of mindshare metrics, positive mindshare, and negative mindshare has been discussed above. Hereinafter, a discussion as to the determining and/or calculating of the remaining coefficients will commence.

Brand affinity metrics are also based on the observed social media behavior of the unique IDs. A unique ID that produces the most positive and or neutral and frequent content about a brand within a set period of time is said to have the brand's affinity. The set period of time or window may be, for example, a business quarter, six months, and/or a year, depending on the brand's context and/or sector. There are different types of brand affinities and/or brand affinity metrics: Newcomers, Incomers, Outgoers and Existings.

Newcomers represent authors, users, and/or unique IDs who have not discussed any of the brands (both the pertinent brand and its competing brands) beforehand. Such an expansion is naturally pursued by brand owners so that the brand may expand by reaching new users, authors, and/or unique IDs who have never discussed any of the brands before. Thus, newcomers represent the authors, users and/or unique IDs engaging in the context and/or sector for the first time. In order to calculate newcomers, the device 100 aggregates unique IDs who are newly engaging with both the brand and the competing brands.

Incomers represent authors, users, and/or unique IDs who previously had a competing brand affinity but now, switched to the brand. In order to calculate newcomers, the device 100 aggregates unique IDs who previously engaged positively the most with the competing brands but have since switched to engage positively the most with the brand.

Outgoers represent authors, users, and/or unique IDs who previously engaged positively the most with respect to the brand but switched to engage positively the most with other competing brands. In order to calculate outgoers, the device 100 aggregates unique IDs who previously engaged positively the most with the brand but have since switched to engage positively the most with the competing brands.

Existings represent authors, users, and/or unique IDs who have maintained the brand's affinity. For example, when unique IDs that already have a Brand's Affinity from the past set period of time (wherein the set period of time or window may be, for example, a business quarter, six months, and/or a year, depending on the brand's context and/or sector), that unique ID is classified as an ID with an existing affinity. In order to calculate existings, the device 100 aggregates unique IDs who have maintained positive engagement with the brand and/or have maintained positive engagement with the brand over a set period of time wherein the set period of time may be, for example, a business quarter, six months, and/or a year, depending on the brand's context and/or sector

As to the determining of the ‘other variables of interest’ coefficient, the device 100 aggregates, gathers, obtains and/or collects the variables of interest and utilizes the respective coefficient in its determining of the market share Y and its subsequent determining and/or calculating of the brand health Hₜ. Such ‘other variable of interest’ may include the price of the brand, the price of the brand in a set period of time (wherein the set period of time may be, for example, a business quarter, six months, and/or a year, depending on the brand's context and/or sector), the trade and distribution support of the brand, merchandising, and/or activations, among other variables.

As to the determining of the ‘period-specific unobservable impacts’ coefficient, the device 100 aggregates, gathers, obtains and/or collects the period-specific unobservable impacts and utilizes the respective coefficient in its determining of the market share Y and its subsequent determining and/or calculating of the brand health Such ‘period-specific unobservable impacts’ may include the promotion(s) of the brand, the seasonal promotion(s) of the brand, the spatial promotion(s) of the brand wherein such spatial promotion(s) may include product placement, product shelf placement, and/or product decorative placement, among other spatial promotion(s), promotional interactions with personnel marketing the brand, and the organization pattern of the point-of-purchase locale (such as a supermarket, mall, etc.) promoting the brand, among other impacts.

Thus, the present invention discloses a method and system utilizing the device 100 having the processor 200 and the memory device 300 to obtain and determine all the relevant social media metrics, unique IDs who engage with both the brand and the competing brands, the set of coefficients that comprise mindshare metrics, brand affinity metrics, other variables of interest, and period-specific unobservable metrics as described above and the subsequent calculating, by the device 100 having the processor 200 and the memory device 300, of the market share Y of the brand via the use of the coefficients, and the ensuing calculation of brand health Hₜ of the brand in real-time via the use of both the market share Y of the brand and the aforementioned coefficients. Thereafter, the present invention discloses the allocating, based on the brand health Hₜ of the brand, marketing resources for the brand wherein such marketing resources may include media buying, campaign spending, marketing expenditures, product modifications, and/or product pricing. Alternatively, the present invention discloses a decisions support system based on the calculated brand health Hₜ or the supporting, based on the brand health Hₜ of the brand, decisions to improve the brand health of the brand wherein such decisions may include continuing to spend more, less, or pivoting marketing campaigns accordingly, identifying product designs, identifying product formulations, experimenting with different brand positioning statements, coming up with new customer value propositions, and/or simulating different and/or various scenarios to see the resulting marketing share into the future.

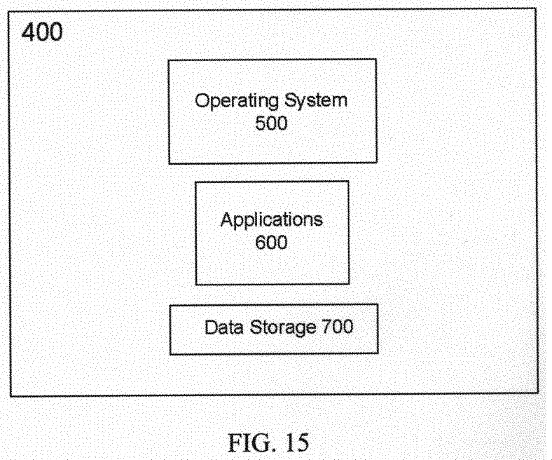

FIG. 15 illustrates at least one non-transitory, computer-readable medium 400 embodying a computer code in which a method for measuring the brand health Hₜ of the brand in real-time and the subsequent allocating of resources or supporting of decisions may be implemented. As shown in FIG. 15, the device 400 may include an Operating System 500, Applications 600, and Data Storage 700.

FIG. 15 illustrates at least one non-transitory, computer-readable medium 400 embodying a computer program code in which a method for measuring the brand health Hₜ of the brand in real-time and the subsequent allocating of resources or supporting of decisions may be implemented. The embodied computer program code of the at least one non-transitory, computer-readable medium 400 may be stored in the Data Storage 700 and thereafter, when required, the computer program code may implement and/or carry out the operations of a method for measuring the brand health Hₜ of the brand in real-time and the subsequent allocating of resources or supporting of decisions via the use of computer operations encapsulated in the Operating System 500 and Applications 600.

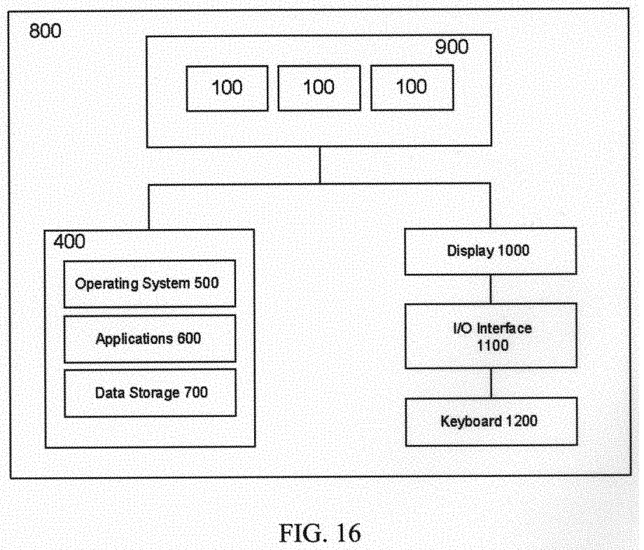

FIG. 16 illustrates at least one system 800 for measuring a brand health Hₜ of the brand in real-time and the subsequent allocating of resources or supporting of decisions. However, it should be appreciated that the system(s) described below is not limited to use with the particular exemplary system 800 shown in FIG. 16 but may be extended to a wide variety of implementations. For example, the exemplary system 800 shown in FIG. 16 for measuring the brand health Hₜ of the brand in real-time and the subsequent marketing resources allocation and/or decisions support system based on the arrived-at brand health Hₜ may be implemented via big-data cloud computing infrastructure, wherein the system 800 comprises a big-data cloud computing infrastructure.

As shown in FIG. 16, the system 800 may include a Central Processing Unit CPU 900, the at least one non-transitory, computer-readable medium 400, a Display 1000, an Input/Output I/O Interface 1100, and a Keyboard 1200.

FIG. 16 illustrates at least one system 800 for measuring a brand health Hₜ of the brand in real-time and the subsequent allocating of resources or supporting of decisions comprising a CPU 900 that further comprises at least one device 100 having at least one processor 200 and at least one memory device 300 storing instructions that are executable on the least one processor 100. Moreover, the at least one system 800 further comprises at least one non-transitory, computer-readable medium 400 embodying computer program code wherein the at least one non-transitory, computer-readable medium 400 is coupled to the at least one device 100 such that the computer program code interacts with a plurality of computer operations to implement the method of measuring a brand health Hₜ of the brand in real-time and the subsequent allocating of resources or supporting of decisions. Moreover, the system 800 further comprises a Display 1000, an I/O interface 1100, and a Keyboard 1200 so as to ensure a user's ability to interact with the system 800 accordingly. A user may, for example, read the information provided by the system 800 (namely a brand health Hₜ of the brand in real-time) while also changing, modifying, and/or updating various input parameters, coefficients, other variables of interest, and period-specific unobservable impacts to see their effects on the brand health Hₜ of the brand in real-time, as described in the disclosure above. The brand health model's implementation on the system 800 will allow for the flow of real-time information as represented by the above-mentioned changing, modifying, and/or updating various input parameters, coefficients, other variables of interest, and period-specific unobservable impacts to see their effects on the brand health Hₜ of the brand in real-time. Note that the above-mentioned time-specific coefficient calculation seen in Equation (8) can allow for the dynamic changing of this time coefficient from real-time to a week, a month, a business quarter, a six-month period, a year, or even a few years, depending on the user(s)' preference. This real-time information flow will allow for the improvement of the hardware efficiency of the system 800 via the auto-scaling of the system 800's aforementioned big-data cloud computing infrastructure, as need be. For example, the hardware components of the system 800 such as the CPU 900 that further comprises at least one device 100 having at least one processor 200 and at least one memory device 300 will be improved upon drastically to be able to have the bandwidth to accept the real-time data required and utilized by the brand health model. Also, the computer-readable medium 400 embodying computer program code wherein the at least one non-transitory, computer-readable medium 400 is coupled to the at least one device 100 such that the computer program code interacts with a plurality of computer operations may also be improved upon drastically so as to accept the aforementioned real-time data required and utilized by the brand-health model. As such, the brand health model becomes a part of the hardware system 800 that constantly updates brand health Hₜ and provides necessary recommendations in the form of marketing resource allocation and/or a decision support system continuously and in real-time. In doing so, the brand health model also improves upon the hardware system 800's efficiency via the auto-scaling of its big-data cloud computing infrastructure.

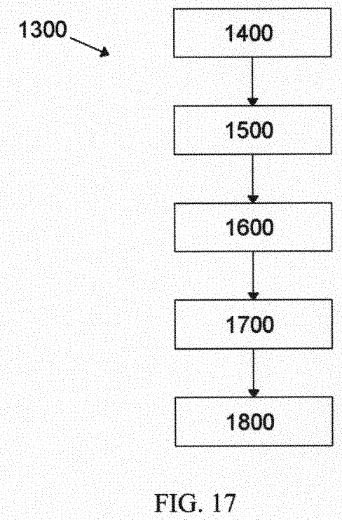

FIG. 17 illustrates at flowchart that illustrates a method 1300 for measuring a brand health Hₜ of the brand in real-time and the subsequent allocating of resources. However, it should be appreciated that the method described below is not limited to use with the particular exemplary method 1300 shown in FIG. 17 but may be extended to a wide variety of implementations. As shown in FIG. 17, the method 1300 comprises step 1400, step 1500, step 1600, step 1700 and step 1800.

FIG. 17 illustrates at least one method 1300 for measuring a brand health Hₜ of the brand in real-time and the subsequent allocating of resources comprising step 1400 obtaining, by one or more devices 100 having a processor 200, unique IDs who engage with both the brand and competing brands during a period of time, step 1500 determining, by the one or more devices 100 having a processor 200, a set of coefficients of the brand, wherein the coefficients are real-time coefficients, step 1600 calculating, by the one or more devices 100 having a processor 200, a market share Y of the brand via the use of the real-time coefficients, step 1700 calculating, by the one or more devices 100 having a processor 200, the brand health Hₜ of the brand in real-time via the use of the market share Y of the brand and the coefficients of the brand, and step 1800 allocating, based on the brand health Hₜ of the brand, marketing resources for the brand.

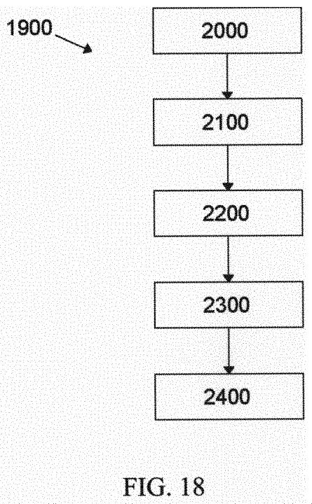

FIG. 18 illustrates at flowchart that illustrates a method 1900 for measuring a brand health Hₜ of the brand in real-time and the subsequent supporting of decisions. However, it should be appreciated that the method described below is not limited to use with the particular exemplary method 1900 shown in FIG. 18 but may be extended to a wide variety of implementations. As shown in FIG. 18, the method 1900 comprises step 2000, step 2100, step 2200, step 2300 and step 2400.

FIG. 18 illustrates at least one method 1900 for measuring a brand health ti of the brand in real-time and the subsequent supporting of decisions comprising step 2000 obtaining, by one or more devices 100 having a processor 200, unique IDs who engage with both the brand and competing brands during a period of time, step 2100 determining, by the one or more devices 100 having a processor 200, a set of coefficients of the brand, wherein the coefficients are real-time coefficients, step 2200 calculating, by the one or more devices 100 having a processor 200, a market share Y of the brand via the use of the real-time coefficients, step 2300 calculating, by the one or more devices 100 having a processor 200, the brand health Hₜ of the brand in real-time via the use of the market share Y of the brand and the coefficients of the brand, and step 2400 supporting, based on the brand health Hₜ of the brand, decisions to improve the brand health of the brand.

Although the present invention has been shown and described in the detailed description above as applied to the illustrative embodiments, it is obvious for the person of ordinary skill in the art that various modifications can be derived based on the above-mentioned embodiments within the scope of the appended claims of the present invention. As such, it will be understood that various omissions, substitutions, and changes in the form and details of the devices and components illustrated can be made without departing from the spirit of the disclosure. As will be recognized, certain embodiments described herein can be embodied within a form that does not provide all the features and benefits set forth herein, as some features can be used or practiced separately from others. All changes which come within the meaning and range of equivalency of the claims are to be embraced within their scope.

It is therefore intended that the foregoing detailed description be regarded as illustrative rather than limiting, and that it be understood that it is the following claims, including all equivalents, that are intended to define the sprit and scope of the invention.

What is claimed is:

1. A method for measuring a brand health of a brand in real-time, comprising:
obtaining, by one or more devices having a processor, unique IDs who engage with both the brand and competing brands during a period of time;
determining, by the one or more devices having a processor, a set of coefficients of the brand, wherein the coefficients are real-time coefficients that further comprise:
mindshare metrics,
brand affinity metrics,
other variables of interest, and
period-specific unobservable impacts;
calculating, by the one or more devices having a processor, a market share of the brand via the use of the real-time coefficients;
calculating, by the one or more devices having a processor, the brand health of the brand in real-time via the use of the market share of the brand and the coefficients of the brand;
allocating, based on the brand health of the brand, marketing resources for the brand.

2. The method of claim 1, wherein the mindshare metrics are calculated by dividing a number of unique IDs who engage with the brand over a number of unique IDs who engage with both the brand and the competing brands.

3. The method of claim 2, wherein a positive mindshare is calculated by dividing a number of unique IDs who generated positive content when engaging with the brand by a number of unique IDs who generated positive content when engaging with both the brand and the competing brands and wherein a negative mindshare is calculated by dividing a number of unique IDs who generated negative content when engaging with the brand by a number of unique IDs who generated negative content when engaging with both the brand and the competing brands.

4. The method of claim 1, wherein the other variables of interest include at least one of a price of the brand, a price of the brand in a set period of time, trade and distribution support of the brand, or merchandising of the brand.

5. The method of claim 1, wherein the period-specific unobservable impacts include at least one of seasonal promotions of the brand or spatial promotions of the brand.

6. The method of claim 1, wherein the brand affinity metrics comprise at least one of newcomers, incomers, outgoers, or existings.

7. The method of claim 6, wherein the newcomers are calculated by aggregating unique IDs who are newly engaging with the brand and the competing brands.

8. The method of claim 6, wherein the incomers are calculated by aggregating unique IDs who previously engaged positively the most with the competing brands but have since switched to engage positively the most with the brand.

9. The method of claim 6, wherein the outgoers are calculated by aggregating unique IDs who previously engaged positively the most with the brand but have since switched to engage positively the most with the competing brands.

10. The method of claim 6, wherein the existings are calculated by aggregating unique IDs who have maintained positive engagement with the brand.

11. The method of claim 1, wherein the marketing resources include at least one of media buying, campaign spending, marketing expenditures, product modifications, or product pricing.

12. A method for measuring a brand health of a brand in real-time, comprising:
obtaining, by one or more devices having a processor, unique IDs who engage with both the brand and competing brands during a period of time;
determining, by the one or more devices having a processor, a set of coefficients of the brand, wherein the coefficients are real-time coefficients that further comprise:
mindshare metrics,
brand affinity metrics,
other variables of interest, and
period-specific unobservable impacts;
calculating, by the one or more devices having a processor, a market share of the brand via the use of the real-time coefficients;
calculating, by the one or more devices having a processor, the brand health of the brand in real-time via the use of the market share of the brand and the coefficients of the brand;
supporting, based on the brand health of the brand, decisions to improve the brand health of the brand.

13. The method of claim 12, wherein the mindshare metrics are calculated by dividing a number of unique IDs who engage with the brand over a number of unique IDs who engage with both the brand and the competing brands.

14. The method of claim 13, wherein a positive mindshare is calculated by dividing a number of unique IDs who generated positive content when engaging with the brand by a number of unique IDs who generated positive content when engaging with both the brand and the competing brands and wherein a negative mindshare is calculated by dividing a number of unique IDs who generated negative content when engaging with the brand by a number of unique IDs who generated negative content when engaging with both the brand and the competing brands.

15. The method of claim 12, wherein the other variables of interest include at least one of a price of the brand, a price of the brand in a set period of time, trade and distribution support of the brand, or merchandising of the brand.

16. The method of claim 12, wherein the period-specific unobservable impacts include at least one of seasonal promotions of the brand or spatial promotions of the brand.

17. The method of claim 12, wherein the brand affinity metrics comprise at least one of newcomers, incomers, outgoers, or existings.

18. The method of claim 12, wherein the decisions include at least one of pivoting market campaigns, identifying product designs, identifying product formulations, or experimenting with different brand positioning statements.

19. A system of measuring a brand health of a brand in real-time, the system comprising:
at least one device having at least one processor,
at least one memory device storing instructions that are executable on the at least one processor, a non-transitory, computer-readable medium embodying computer program code, the computer-usable medium being coupled to the at least one device, the computer program code interacting with a plurality of computer operations to implement the method of claim 1.

20. A non-transitory, computer-readable medium embodying computer program code, the computer program code interacting with a plurality of computer operations to implement the method of claim 1.
